(19) United States
(12) Patent Application Publication
(10) Pub. No.: US 2024/0035864 A1
(43) Pub. Date: Feb. 1, 2024

(54) DEVICE FOR MEASURING A FLOW PARAMETER OF A FLUID

(71) Applicants: LA ROCHELLE UNIVERSITE, La Rochelle (FR); UNIVERSITE DE POITIERS, Poitiers (FR); CENTRE NATIONAL DE LA RECHERCHE SCIENTIFIQUE, Paris (FR)

(72) Inventors: Anas SAKOUT, Lagord (FR); Laurent RAMBAULT, Saint Benoit (FR); Kamel ABED-MERAIM, Saint -Xandre (FR); Cauet SEBASTIEN, Migne Auxances (FR); Erik ETIEN, Poitiers (FR); Thierry DOGET, Poitiers (FR)

(21) Appl. No.: 18/266,378

(22) PCT Filed: Dec. 9, 2021
(86) PCT No.: PCT/EP21/85076

§ 371 Date: Jun. 9, 2023

(30) Foreign Application Priority Data
Dec. 11, 2020 (FR) FR2013097

(51) Int. Cl. G01F 1/325; G01F 1/32

(52) U.S. Cl. CPC G01F 1/3266; G01F 1/3218

(57) ABSTRACT

A device for measuring at least one flow parameter of a fluid through a duct, in particular the flow rate thereof, including a portion forming an obstacle, intended to be brought into contact with the flow, the shape of which being chosen so as to generate turbulence in the flow; a vibration sensor sensitive to vibrations caused on the portion forming an obstacle by the turbulence; a processing unit configured to calculate the flow parameter of the fluid based on at least one vibration signal delivered by the vibration sensor.

### TECHNICAL FIELD

The present invention relates to the field of measurement of the speed and/or flow rate of a fluid in flow.

It is notably, but not solely, applicable in fluid installations, notably industrial installations, such as aeraulic or hydraulic installations for example.

More particularly, it is advantageously applicable in the monitoring and regulation of suction and blowing ventilation circuits, air treatment circuits, air conditioning circuits, hot air heating circuits, dust removal circuits, smoke removal and drying circuits.

### PRIOR ART

Flow rate measurements are elements essential to the implementation and optimization of industrial processes.

Many flowmeters which make it possible to measure the flow rate of a fluid in flow are currently offered on the market for industrial installation, whether in the water distribution, petrochemical or agrifood domain, for example.

Flowmeters that can be cited include the vortex effect flowmeters, the mass flowmeters (also called Coriolis effect flowmeters), the Doppler effect flowmeters, electromagnetic or ultrasound flowmeters.

However, these flowmeters are generally mounted on flow ducts by flange fitting. Thus, all of the flow must converge toward the measurement section of the flowmeter, which increases head loss of the flow.

Moreover, in order to guarantee flow rate measurement accuracy, each type of flowmeter is generally limited to one range of duct diameters, of temperatures and of kinds of fluid. For example, the doppler effect flowmeter is recommended for greater duct diameters, in particular ranging up to approximately 5 m, whereas the vortex effect flowmeter is recommended for duct diameters not exceeding 0.5 m.

Disturbances that are inherent to the operation of the industrial installation can moreover considerably reduce the accuracy of the flow rate measurements: for example, the vibrations of the industrial installation in the case of a vortex effect flowmeter or even the magnetic field radiated by the industrial installation and its environment in the case of an electromagnetic flowmeter.

There are so-called insertion flowmeters intended to be immersed in a duct and which therefore do not require a flange mounting, such as the thermal effect flowmeters, notably the hot wire or hot film systems, or those based on pressure measurements, notably Pitot tubes which make it possible to determine the speed of a fluid in flow from the measurement of a pressure difference.

The hot wire or hot film system is an instrument placed in the fluid in flow that makes it possible to determine the flow rate of a fluid in flow from its speed. Nevertheless, the implementation thereof is complex and costly, particularly because the heating wire or film is very brittle and ages rapidly, which necessitates regular maintenance.

Furthermore, the fragility of the thermal effect insertion flowmeters and those based on pressure measurements does not allow them to be used in fluid flows filled with water vapor, solvent vapors, smoke and/or solid particles.

U.S. Pat. Nos. 4,526,040, 5,321,990, US 2005/217389 and U.S. Pat. No. 5,563,350 describe vortex effect flow rate sensors.

The principle of a vortex effect flow rate sensor is to create an obstacle to the flow of the fluid, so that “great” vortexes are formed downstream of the obstacle. The laws of fluid mechanics demand that the vortex detachment frequency then be proportional to the average speed of the flow.

The vortex detachment frequency can be determined by counting, by detecting the pressure variations induced by each vortex detachment in the vicinity of the obstacle-forming part.

Typically, in these sensors, the obstacle-forming part occupies a significant portion of the section of the duct so as to sufficiently disturb the flow to generate therein the vortices sought, and extends generally over the entire internal diameter of the duct.

The result of this is a not inconsiderable head loss, and an increased risk of obstruction of the free passage by buildup of material, when the fluid is filled, which can necessitate frequent maintenance operations to clean the flowmeter.

Moreover, the counting of the detachment of vortices is performed using a sensor secured to the obstacle-forming part. So as to facilitate the vibration of the obstacle-forming part by the detachment of vortices and the counting thereof, the obstacle-forming part is rigidly fixed to the duct.

Because of the size of the obstacle-forming part and the need to fix it rigidly to the duct, the placement of the flowmeter generally necessitates particular provisions in the duct, for example the presence of a flat for fixing a flange (U.S. Pat. No. 5,321,990 or U.S. Pat. No. 4,526,040) or of a housing for holding the obstacle-forming part at its free end (U.S. Pat. No. 5,563,350 or US 2005/0217389).

Since vibrations other than those induced by the detachments of vortices are damaging to the counting of the latter, a second vibration sensor is generally present to allow, by signal processing, ambient vibrations to be eliminated and thus the signal/noise ratio of the signal useful to the counting of the vortex detachments to be improved (see U.S. Pat. No. 4,526,040 for example, which describes signal processing that relies on the use of a low-pass filter to eliminate the high frequencies before attacking a Schmitt trigger transforming the resultant signal into rectangular pulses that make it possible to count the vortex detachments).

An alternative solution, described in U.S. Pat. No. 5,563,350, consists in providing particular damping means to isolate the vibration sensor of the obstacle-forming part from the external vibrations, the obstacle-forming part nevertheless remaining rigidly linked to the duct.

Vortex effect sensors generally operate well for a flow that has a relatively high Reynolds number, typically greater than 10 000; for a flow with a lower Reynolds number, a convergent is used, which entails cutting the duct to incorporate the sensor, and performing a careful mounting to avoid for example any bad weld from disrupting the flow. The presence of this convergent results in an additional head loss.

### DISCLOSURE OF THE INVENTION

The invention consequently aims to provide a robust and inexpensive measurement device which can be easily mounted on a duct in which a fluid is circulating and which makes it possible to overcome all or some of the abovementioned drawbacks of the flowmeters of the prior art.

### SUMMARY OF THE INVENTION

Measurement Device

The invention therefore relates to a device for measuring at least one flow parameter of a fluid in a duct, notably the flow rate thereof, comprising:
an obstacle-forming part, intended to be placed in contact with the flow, having a form chosen so as to generate turbulences in the flow, notably around the obstacle-forming part,
a vibration sensor sensitive to the vibrations induced on the obstacle-forming part by the turbulences,
a processing unit configured to calculate the flow parameter of the fluid from at least a vibratory signal delivered by the vibration sensor.

The measurement device according to the invention can make it possible to measure the speed and/or the flow rate of the fluid in real time and in a robust manner.

The cost of the measurement device according to the invention is significantly lower than the devices of the prior art, notably the vortex effect flowmeters.

The measurement device according to the invention can be mounted simply and rapidly on an existing duct, notably that of a fluid installation, without having to use a flange mounting, contrary to the devices of the prior art, notably the vortex or Coriolis effect flowmeters.

The measurement device according to the invention is also of smaller size than the devices of the prior art, which also facilitates the implementation thereof on an existing duct.

The operation of the measurement device according to the invention relies on the following principle. When the obstacle-forming part is placed in contact with the flow, the obstacle-forming part generates turbulences in the flow, and vortices are formed notably around the obstacle-forming part. The periodic detachment of these vortices induces vibrations on the obstacle-forming part, and notably a characteristic vibratory frequency, which are measured by the vibration sensor which delivers a corresponding vibratory signal to the processing unit. The processing unit then calculates, from at least the vibratory signal delivered by the vibration sensor, the flow parameter of the fluid, notably the speed and/or the flow rate thereof. Indeed, the vibrations induced on the obstacle-forming part by the turbulences, and in particular the characteristic vibratory frequency induced on the obstacle-forming part by the detachment of the vortices and the turbulence of the flow around the obstacle-forming part, will make it possible to work back indirectly to the image of the speed of flow of the fluid.

Compared to a vortex effect sensor of the prior art, it is possible in the invention for the obstacle-forming part to occupy only a small portion of the passage section offered to the fluid in the duct; indeed, there is no need in the invention to generate vortices whose detachment is accompanied by strong local pressure variations, and therefore to use, to generate these vortices, an obstacle-forming part occupying a significant portion of the passage section, or to count the number of detachments of these vortices.

In addition, the sensor according to the invention makes it possible to measure low rates of flow, with Reynolds number lower than 4000.

The vibration sensor can be an accelerometer, notably piezoelectric, notably with one or three axes. The use of a piezoelectric sensor can be advantageous because of its wide measurement extent and/or its sensitivity to a wide frequency band.

The measurement extent of the vibration sensor can be between 0 and 100 g.

The bandwidth of the vibration sensor can be between 5 and 20 000 Hz.

The vibration sensor can be arranged inside the obstacle-forming part. This can allow the vibration sensor to be tightly isolated from the fluid.

The obstacle-forming part can comprise a body defining an internal housing receiving the vibration sensor, the internal housing preferably being tightly isolated from the fluid.

The vibration sensor can be fixed against a wall of said body.

Preferably, the weight of the vibration sensor is chosen so that the vibration sensor does not disturb, or disturbs as little as possible, the vibrations induced by the turbulences of the flow on the obstacle-forming part. The weight of the vibration sensor is preferably less than or equal to 30 grams, better less than or equal to 20 grams, even better less than or equal to 10 grams.

The device can comprise a support, preferably having a tubular form, coupled at one of its ends to the obstacle-forming part, notably made of a single piece therewith.

The interior of the support can be connected with the internal housing of the obstacle-forming part. Preferably, the interior of the support and the internal housing of the obstacle-forming part are tightly isolated from the fluid.

The interior of the support can receive at least one cable linked to the vibration sensor. The cable can thus be tightly isolated from the fluid.

The cable can make it possible to electrically power the vibration sensor and/or transmit the vibratory signal delivered by the vibration sensor to the processing unit.

In the measurement device according to the invention, the vibration sensor, and notably the cable making it possible to electrically power it, are not in contact with the fluid. The obstacle-forming part intended to be placed in contact with the flow does not provoke any heating up of the fluid. The measurement device according to the invention thus offers the advantage of being able to be used in an ATEX zone.

The device can comprise a fixing element, notably a cable gland, making it possible to fix the support to the duct.

The fixing element can comprise an element ensuring a sealing and/or damping function, notably an antivibratory baseplate. This can make it possible to reduce, even cancel, the sensitivity of the vibration sensor to the vibrations of the duct, which are notably induced by the flow, and generally, by the overall operation of the fluid installation, such that the vibration sensor is sensitive only to the vibrations induced on the obstacle-forming part by the turbulences of the flow.

The device can comprise at least one external vibration sensor sensitive to the vibrations of the duct, which are notably induced by the flow, and generally, by the overall operation of the fluid installation. The external vibration sensor can be intended to be positioned on an outer face of the duct or any other location making it possible to measure the vibrations of the duct. The external vibration sensor can be an accelerometer, notably piezoelectric, notably with one or three axes. It can have the same characteristics as the vibration sensor or different characteristics. In the latter case, this can allow the vibration sensor and the external vibration sensor to each detect a different vibratory frequency.

The processing unit can be configured to calculate the flow parameter of the fluid from at least the vibratory signal delivered by the vibration sensor and from an external vibratory signal delivered by the external vibration sensor. This can make it possible to improve the accuracy of the calculation of the flow parameter of the fluid by making it possible to decouple the vibratory signal delivered by the vibration sensor into a component corresponding to the vibrations induced on the obstacle-forming part by the turbulences of the flow and a component corresponding to the vibrations of the duct.

The external vibration sensor can be linked to at least one cable making it possible to electrically power the external vibration sensor and/or transmit the external vibratory signal delivered by the external vibration sensor to the processing unit. This cable can be housed or not at least partly inside the support.

The flow parameter of the fluid can be the velocity or the flow rate thereof, notably by volume. The determination of the speed of flow of the fluid can make it possible to work back to its rate of flow.

As is mentioned above, the form of the obstacle-forming part is chosen to generate turbulences in the flow, notably around the obstacle-forming part. Thus, the vibrations induced on the obstacle-forming part by the turbulences of the flow depend on the form of the obstacle-forming part.

The form of the obstacle-forming part can be chosen as a function of the range of flow rate to be measured and/or as a function of the nature of the fluid.

The obstacle-forming part can have a general form of a sphere, of a half-sphere, of a disk, of a cylinder, of a half-cylinder (cut lengthwise) or of a beam, notably with square, rectangular or circular cross section, or any form suitable for generating turbulences in the flow, notably around the obstacle-forming part.

In the case where the obstacle-forming part has a hemispherical form, its base is preferably oriented parallel to the direction of flow of the fluid in the duct.

In the case where the obstacle-forming part has a beam form, its longitudinal axis is preferably oriented at right angles to the direction of flow of the fluid in the duct.

In the case where the obstacle-forming part has a disk form, its main faces are preferably oriented at right angles to the direction of flow of the fluid in the duct.

In the case where the obstacle-forming part has a cylinder form, its bases are preferably oriented at right angles to the direction of flow of the fluid in the duct.

A greater dimension of the obstacle-forming part can be between 1 and 30 cm, better between 1 and 20 cm, even better between 1 and 10 cm. Thus, the small size of the obstacle-forming part can make it possible to facilitate the implementation of the device on a duct.

The obstacle-forming part can have a surface in contact with the flow whose area is between 1 and 500 cm², better between 1 and 250 cm², even better between 1 and 100 cm².

The obstacle-forming part can extend over a distance which represents less than half the internal diameter of the duct. Thus, the obstacle-forming part hampers the flow less by comparison to the known vortex effect sensors, and the risk of clogging is reduced.

In addition to the form of the obstacle-forming part, the vibrations induced on the obstacle-forming part by the turbulences of the flow around the obstacle-forming part depend also on the material of the obstacle-forming part.

The material of the obstacle-forming part can be chosen as a function of the flow rate range to be measured and/or as a function of the nature of the fluid.

The obstacle-forming part can be produced in a metallic material, notably stainless steel, a plastic, composite or any other suitable material. The use of a metallic material such as stainless steel, for example, can be chosen in the case where the fluid is for example corrosive.

The obstacle-forming part can have been manufactured notably by an additive manufacturing technique.

The device can comprise a temperature sensor, notably arranged inside the obstacle-forming part. The temperature sensor can deliver a temperature signal to the processing unit. Given that the majority of vibration sensors are influenced by temperature, such a temperature sensor can make it possible to monitor the temperature, and possibly to signal when the temperature deviates from that used for the calibration of the vibration sensor. Such a temperature sensor can also make it possible to measure, notably in real time, the temperature of the fluid in flow.

The device can comprise a wireless transmission means transmitting to the processing unit at least the vibratory signal delivered by the vibration sensor, and, if appropriate, the external vibratory signal delivered by the external vibration sensor and/or the temperature signal delivered by the temperature sensor. The transmission means can be configured to use a “Bluetooth”, “Wi-Fi” or LPWAN network, such as “Sigfox”, “LoRa”, “Neul”, “Nwave”, LTE-M or NB-loT.

Preferably, the processing unit is arranged outside of the duct.

The processing unit can comprise a control circuit, notably a microcontroller or any other circuit suitable for performing the functions sought. The control circuit can exchange data with a memory which contains an operating system. The memory can be SD, USB and/or SSD. The memory can be removable, such as a memory card for example.

The processing unit can incorporate in its memory the position of the obstacle-forming part and/or of the vibration sensor along the duct.

The processing unit can incorporate in its memory the calibration curve of the vibration sensor.

The processing unit can comprise connections such as a micro-USB port, a serial port or other which makes it possible to program it, to parameterize it or to retrieve stored data.

The processing unit can be configured to calculate the flow parameter of the fluid by performing a frequency analysis of the vibratory signal delivered by the vibration sensor. Such a frequency analysis can make use of any information borne by a relatively wide range of frequencies, contrary to the processing generally applied in the known vortex effect sensors, which aims to count the number of vortex detachments, and for which this information is not useful. The processing unit can thus be configured to calculate, in the frequency analysis, a frequency spectrum of a frequency range at least 500 Hz wide. The vibratory spectrum used in the frequency analysis is advantageously obtained by FFT, the sampling frequency of the signal being preferably greater than or equal to 2 kHz. The sampling can be performed by storing the sampled values in sliding time windows, so as to be able, upon each new frequency spectrum calculation, to reuse a part of the values already sampled and already used to calculate at least one frequency spectrum previously calculated. The acquisition time is great compared to the period of the turbulence phenomena, which makes it possible to smooth and improve the accuracy, this acquisition time thus being able to be greater than or equal to 1 s. It is for example possible to use at least three sliding windows, by renewing, after each frequency spectrum calculation, the sampling values for only the most recent window, and by shifting the value of each window to the consecutive past window. The processing unit can be configured to calculate a quantity representative of the flow rate of the fluid, by integration over the range of frequencies retained for a quantity representative of the amplitude of the vibrations. This integration is done for example over a frequency range ranging from a frequency F_min of between 50 and 150 Hz, for example of the order of 100 Hz (+/−20%), to a frequency F_max for example greater than or equal to 500 Hz, for example of the order of 1000 Hz (+/−20%), such a range covering the vibrations generated by the turbulence in the fluid in a general manner (detachment of the vortices generated by the obstacle, secondary vortices, vibrations close to the wall linked to the boundary layer and to the recirculation zones, etc.) and not only those induced by possible vortex detachments. After calibration, it is possible, from this value calculated by integration, to deliver a fluid flow rate or speed of flow value in the duct that is relatively close to the real value. The acquisition and the processing of the acquired signal can be performed easily in a microcontroller, for example a microcontroller of STM 32 type.

The measurement device can be used to determine the flow rate of the fluid in the duct within a fluid flow rate ranging up to 1000 m³/s and/or a fluid temperature range ranging from −20° C. to 150° C.

Measurement Installation

Another subject of the invention, independent of or in combination with the above, an installation for measuring at least one flow parameter of a fluid, notably its flow rate, comprising:
a fluid flow duct,
at least one measurement device as defined above, for measuring the flow parameter of the fluid in the duct.

The duct can be a duct of a fluid installation, notably industrial, such as an aeraulic or hydraulic installation, for example.

For example, the duct is a ventilation duct, notably a suction or blowing duct or any duct allowing the flow of a fluid.

The installation can comprise a plurality of measurement devices in a restricted portion of the duct or distributed along the duct. In the case where the measurement devices are distributed along the duct, this can make it possible to produce a mapping of all of the duct.

The measurement devices can be distributed regularly, or not, along the duct.

Each device can be identical or different. For example, the measurement devices differ by the form of the obstacle-forming part and/or the characteristics of the vibration sensor, notably its measurement extent. This can allow each measurement device to be adapted to measure a different flow rate range, which is particularly advantageous in the case where the flow of the fluid in the duct undergoes great flow rate variations over time, for example.

The plurality of measurement devices can share a single processing unit.

The processing unit can incorporate in its memory the position of the obstacle-forming part and/or of the vibration sensor of each measurement device along the duct.

The processing unit can be configured to trigger, notably autonomously and/or in real time, at least one corrective action on the fluid installation in the case where the flow parameter of the fluid calculated by the processing unit and/or the temperature measured by the temperature sensor deviates from a predetermined range of values.

For example, the corrective action is an increase or a reduction of the flow rate of the flow.

The processing unit can thus make it possible to optimize the performance levels of the fluid installation, for example in terms of suction in the case of an aeraulic installation, for example, of heat exchanges, of reduction of sound nuisances.

In the case where the vibration sensor is a piezoelectric accelerometer with one or three axes, its positioning is preferably identified in space. This can make it possible to register the direction of the axis or axes of the piezoelectric accelerometer. Indeed, the modulus of the acceleration vector is independent of the positioning of the three axes of the piezoelectric accelerometer which form the protection base.

Measurement Process

Also a subject of the invention, independently of or in combination with the above, is a method for measuring at least one flow parameter of a fluid in a duct, notably the flow rate thereof, using a measurement device as defined above, comprising the steps of:
a) detecting, using the vibration sensor, the vibrations induced on the obstacle-forming part by the turbulences,
b) calculating, using the processing unit, the flow parameter of the fluid from at least the vibratory signal delivered by the vibration sensor.

The method can further comprise a preliminary step of calibration of the vibration sensor.

The fluid can be of any type, including corrosive, toxic and/or abrasive.

The fluid can be a liquid or a gas, notably filled with solid particles.

In a variant, the fluid is a gas, notably air, filled with water vapor, solvent vapors, smoke and/or solid particles such as dust, sawdust or wood chips.

In another variant, the fluid is a liquid, notably a suspension or an emulsion.

The method can further comprise a step consisting in cleaning, notably periodically, the outer surface of the obstacle-forming part. Such cleaning may be necessary in particular in the case where the fluid is a wet gas and filled with solid particles.

The method can further comprise a step consisting in detecting the vibrations induced on the fluid flow duct using at least one external vibration sensor sensitive to the vibrations of the duct, and in calculating, using the processing unit, the flow parameter of the fluid from at least the vibratory signal delivered by the vibration sensor and from an external vibratory signal delivered by the external vibration sensor.

The external vibration sensor can be positioned on an outer face of the duct.

The method can further comprise a step of activation of an alarm and/or a step of stopping of the flow of the fluid in the duct when the flow parameter of the fluid calculated by the processing unit and/or the external vibratory signal delivered by the external vibration sensor reaches a certain predefined threshold.

The method according to the invention, applied to the measurement of the flow rate, notably by volume, or of the speed of flow of the fluid, can comprise the following steps:
a. calculation of a frequency spectrum of the vibratory signal delivered by the vibration sensor detecting the vibrations induced on the obstacle-forming part,
b. calculation of a quantity representative of the speed of the flow (also called scalar indicator) by integration of the amplitude of the vibratory signal or of a function representative thereof, the integration preferably being performed over the frequency spectrum from a low frequency F_min to a high frequency F_max,
c. determination of the flow rate or of the speed of flow with a transfer function giving, from the scalar indicator or from the image thereof by a function, notably a linearization function, for example logarithmic, the value of the flow rate or of the speed of flow, the parameter or parameters of this transfer function having been determined by prior calibration.
   The frequencies F_min and F_max can be adjusted with respect to the type of fluid and thus allow the sensor to function correctly with a filled fluid. The frequencies F_min and F_max can also be adjusted according to the vibratory characteristics of the system and also with respect with respect to the vibratory environment of the system.
   The integration operation renders the sensor robust to the measurement and provides it with good repeatability.
   The calculation of the spectrum in step a) can be performed with a Fourier transform, preferably of FFT (Fast Fourier Transform) type.
   The spectrum is preferably determined for the extent of the frequencies [0 Hz; Fs] in which Fs is the sampling frequency of the signal. The sampling frequency is for example 2 kHz.
   The spectrum can also be determined for a more reduced range of frequencies, when F_max is lower than Fs.
   The scalar indicator determined in step b) by integration of the spectrum over the range [F_min; F_max] can be given by the relationship ∫_{F_min}^{F_max}X(f).df
   X(f) being the value of an element of the spectrum for a frequency, f, lying within the range [F_min; F_max].
   For example, F_min=100 Hz and F_max=1 kHz.
   X(f) is for example equal to the square of the amplitude of the vibratory signal at the frequency f.
   The trend curve of the scalar indicator for different flow speeds can be linearized by using the logarithm function. This function can give a better visibility of the measurement for low speeds and a lesser deformation of the curve P*max as a function of the speed of flow of the fluid.

Manufacturing Method

Another subject of the invention, independently of or in combination with the above, is a method for manufacturing a measurement device as defined above, wherein the obstacle-forming part is manufactured by an additive manufacturing technique or any other suitable technique.

Preferably, the method comprises, after the step of manufacturing of the obstacle-forming part, a step of fixing of the vibration sensor to the interior of the obstacle-forming part.

The method can further comprise a step consisting in manufacturing by a

### BRIEF DESCRIPTION OF THE DRAWINGS

FIG. 1 FIG. 1 is a schematic cross section of an example of a measurement device according to the invention in the transverse plane of a duct on which the device is mounted,

FIG. 2 is a view similar to FIG. 1 of a variant embodiment,

FIG. 3 FIG. 3 represents another example of a measurement device according to the invention,

FIG. 4 FIG. 4 represents another example of a measurement device according to the invention,

FIG. 5 FIG. 5 represents another example of a measurement device according to the invention,

FIG. 6 FIG. 6 represents another example of a measurement device according to the invention,

FIG. 7 FIG. 7 represents an example of a transfer function obtained after calibration, also called “calibration curve”, making it possible, with knowledge of a scalar indicator obtained by integration in a vibratory spectrum, to determine the speed of flow of the fluid,

FIG. 8 is a block diagram illustrating steps of an example of calculation of the flow rate.

### DETAILED DESCRIPTION

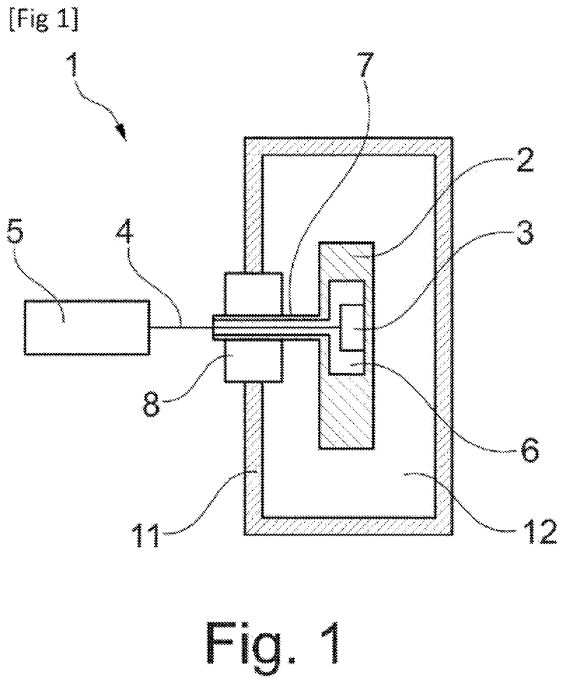

FIG. 1 illustrates an example of a measurement device 1 according to the invention, mounted on a flow duct 11 of a fluid 12.

The device 1 comprises an obstacle-forming part 2, a vibration sensor 3, a support 7 and a processing unit 5.

The obstacle-forming part 2 is inserted into the fluid 12 flow duct 11. The obstacle-forming part 2 has a form chosen to generate turbulences in the flow, notably around the obstacle-forming part 2.

The obstacle-forming part 2 is arranged inside the duct 11. It can be positioned at the center of the duct 11, as illustrated in FIG. 1. As a variant, it can be positioned between the wall and the center of the duct 11.

The vibration sensor 3, preferably an accelerometer with one or three axes, is configured to detect the vibrations induced on the obstacle-forming part 2 by the turbulences and generate a corresponding vibratory signal 4. The vibration sensor 3 is arranged inside the obstacle-forming part 2, in an internal housing 6 defined by the body of the obstacle-forming part 2. Thus, the vibration sensor 3 is encapsulated in the obstacle-forming part 2, which makes it possible to tightly isolate it from the fluid 12 in flow. Within the internal housing 6, the vibration sensor 3 is fixed against a wall of the body of the obstacle-forming part 2.

The obstacle-forming part 2 is coupled at one of its ends to a tubular support 7, preferably made of a single piece. The interior of the support 7 is connected with the internal housing 6 of the obstacle-forming part 2.

The vibration sensor 3 is linked to a cable 4 which crosses the interior of the support 7. This cable 4 makes it possible to electrically power the vibration sensor 3 and/or transmit the vibratory signal 4 delivered by the vibration sensor 3 to the processing unit S.

The support 7 is fixed onto the duct 11 by means of a fixing element 8, notably a cable gland. The fixing element 8 can comprise an element ensuring a sealing and/or damping function, such as an antivibratory baseplate, for example.

The processing unit 5 receives the vibratory signal 4 delivered by the vibration sensor 3 and is configured to calculate a flow parameter of the fluid, notably the speed or flow rate thereof, from at least the vibratory signal 4 delivered by the vibration sensor 3.

The duct 11 can be a duct of a fluid installation, for example aeraulic, notably a suction duct, and the fluid 12 in flow in the duct 11 can be air, wet or not, for example filled with sawdust. The speed of flow of the fluid 12 within the duct 11 can be between 15 and 35 m/sec for example.

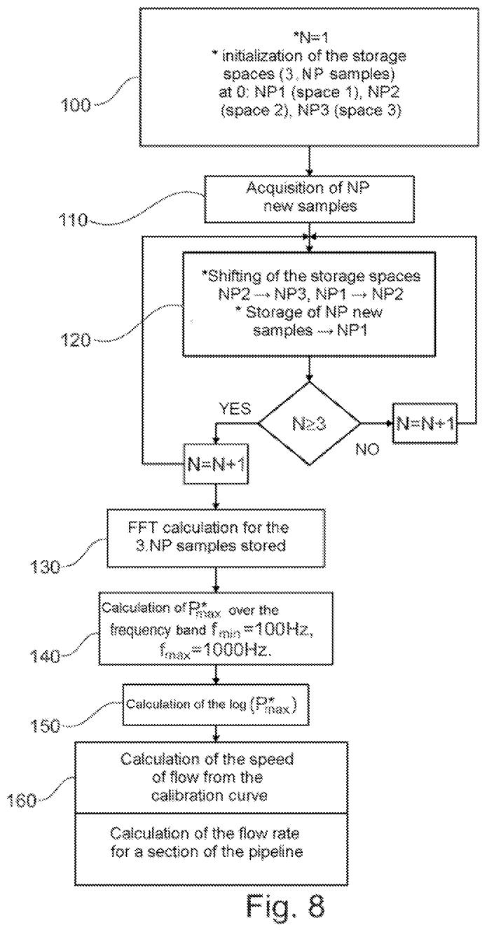

To calculate the value of the flow rate from the vibratory signal delivered by the sensor 3, the method can be as illustrated in FIG. 8.

The processing unit 5 is for example a microcontroller, the sensor 3 being linked to an input thereof, such that the microcontroller can sample the vibration amplitude as a function of time over a predefined time period, for example 1 s or more.

3.NP temporally consecutive values, from the sensor 3, can thus be stored in step 110 in three tables NPi (i=1, 2 and 3) of the processing unit 5, previously initialized in step 100 (each “table” being also called “storage space”).

Next, the values successively loaded into the three tables can be shifted in time in step 120, so as to constitute sliding sampling time windows, the values stored in the table NP2 being stored in the table NP3 and replacing the oldest values contained therein, the values contained in the table NP1 being stored in the thus freed table NP2, and the newly sampled values, the most recent ones, being loaded in the table NP1.

In step 130, the frequency spectrum is calculated from the set of 3.NP values stored in the three tables NP1, NP2, NP3, which follow one another with a delay linked to the sampling frequency.

Next, in step 140, a scalar indicator P*ₘₐₓ is calculated that is equal to the integration of the square of the amplitude of the vibratory signal in the frequency spectrum, between the frequencies 100 and 1000 Hz, for example.

This value P*ₘₐₓ is representative of the speed of the flow, as illustrated in FIG. 7. The logarithm of it can be taken in step 150 (optional).

In FIG. 7, the frequency spectrum having led to one of the points of the calibration curve is represented.

To calibrate the device, flow rate measurements can be conducted with any type of flowmeter whose measurement accuracy is known, which makes it possible to define the parameters of the transfer function giving, from the calculation of P*ₘₐₓ or the logarithm thereof, the value of the speed of the flow or of the volume flow rate, knowing the passage section.

It is thus possible to determine the bijective curve, notably the straight line (at least by segments) giving the speed of the flow from P*max or from the logarithm of P*max.

Once the calibration has been done, it is possible, upon each new calculation of P*max, to determine, by application of the transfer function, the speed of the flow in step 160, then the flow rate, if appropriate.

Such a method which involves only the signal delivered by the vibration sensor 3 gives a satisfactory accuracy for many applications, and offers the advantage of great simplicity of implementation, since the obstacle-forming part 2 is of reduced size and can be easily introduced into the duct, and there is no need to use a second sensor to improve the useful signal/noise ratio.

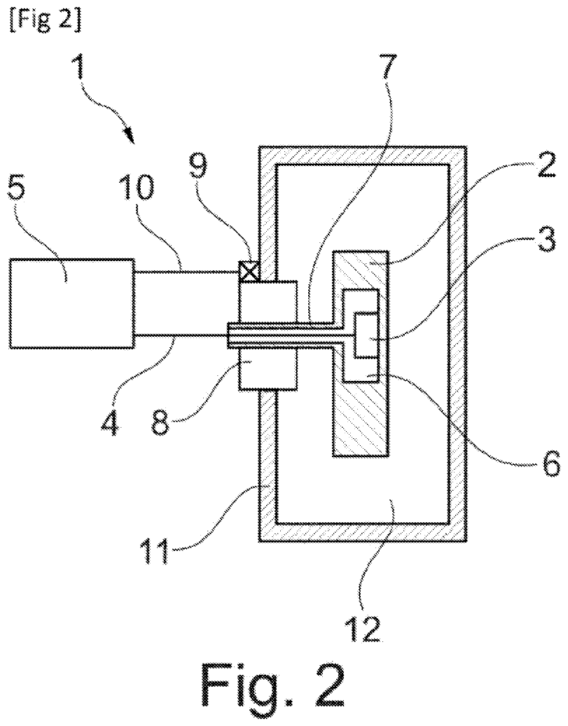

However, as illustrated in FIG. 2, the measurement device 1 can comprise an external vibration sensor 9, preferably an accelerometer with one or three axes, configured to detect the vibrations of the duct 11, notably induced by the flow of the fluid 12, and generate a corresponding external vibratory signal 10.

The external vibration sensor 9 is arranged on an outer surface of the duct 11. The sensor 9 is linked to a cable 10 making it possible to electrically power it and/or transmit the external vibratory signal 10 delivered by the external vibration sensor 9 to the processing unit 5. Thus, the processing unit 5 also receives the external vibratory signal 10 delivered by the external vibration sensor 9 and is configured to calculate the flow parameter of the fluid, notably the speed or flow rate thereof, from at least the vibratory signal 4 delivered by the vibration sensor 3 and from the external vibratory signal 10 delivered by the external vibration sensor 9.

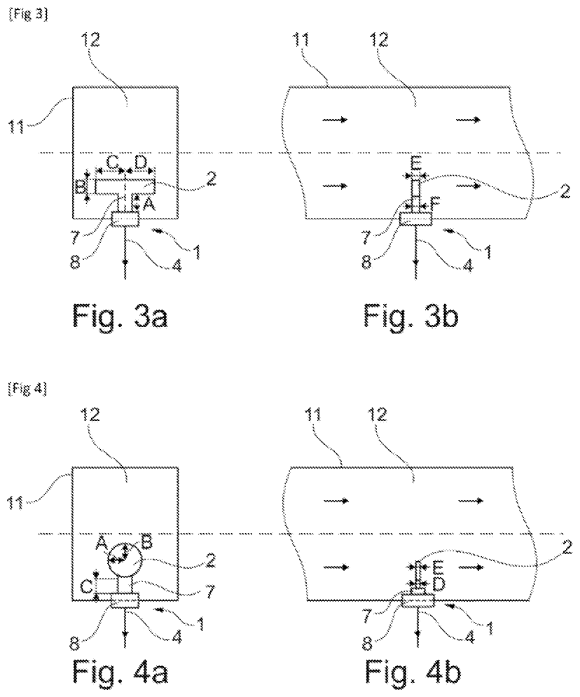

FIGS. 3 to 6 schematically represent examples of measurement devices 1 according to the invention, mounted on the duct 11, observed on a transverse plane of the duct 11 (FIGS. 3a), 4a), 5a) and 6a)) and on a longitudinal plane of the duct 11 (FIGS. 3b), 4b), 5b) and 6b)). The examples of devices 1 represented in FIGS. 3 to 6 differ by the form of the obstacle-forming part 2.

The latter can have a beam form whose longitudinal axis is oriented at right angles to the direction of flow of the fluid 12 (FIG. 3), or a cylinder form, the bases of which are oriented at right angles to the direction of flow of the fluid (FIG. 4).

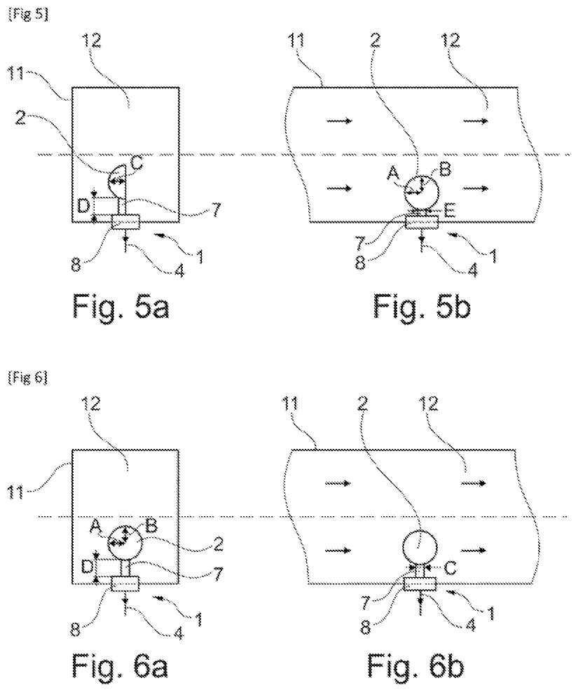

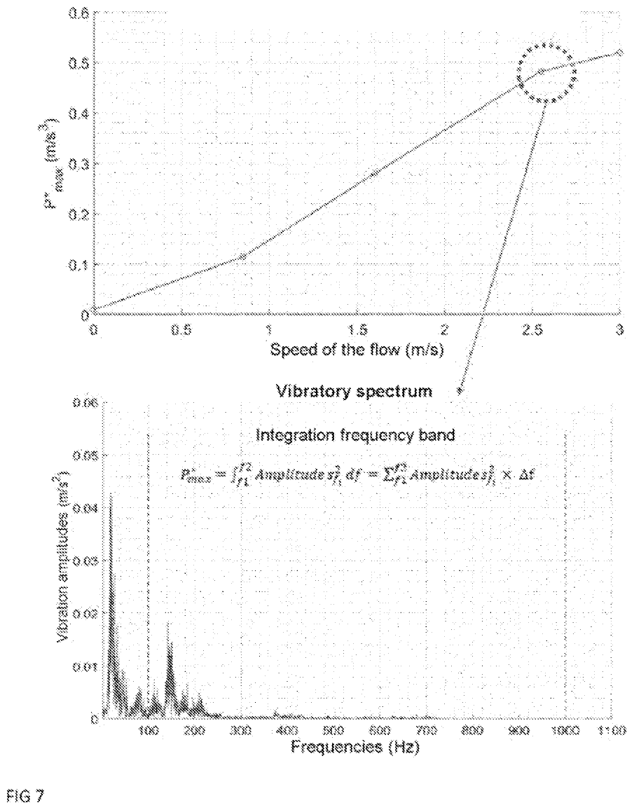

The obstacle-forming part 2 can also have a hemispherical form whose base is oriented parallel to the direction of flow of the fluid 12 (FIG. 5) or a spherical form (FIG. 6).

The dimensions A, B, C, D, E and F of FIGS. 3 to 6 lie for example between 1 and 30 cm.

The invention is not limited to the examples which have just been described.

For example, the measurement device is not limited to the determination of a flow parameter of a fluid in a duct such as the speed or flow rate thereof. Other parameters can be determined on the basis of the vibratory signal 4 delivered by the vibration sensor 3 and possibly on the basis of the external vibratory signal 10 delivered by the external vibration sensor 9. The processing unit 5 can thus make it possible to know in real time the state of operation of the fluid installation, and can notably make it possible to conduct a diagnosis, even conditional and/or predictive maintenance of the installation.

1. A device for measuring at least one flow parameter of a fluid in a duct, comprising:
an obstacle-forming part, configured to be placed in contact with the flow, having a form chosen so as to generate turbulences in the flow,
a vibration sensor sensitive to the vibrations induced on the obstacle-forming part by the turbulences,
a processing unit configured to calculate the flow parameter of the fluid from at least a vibratory signal delivered by the vibration sensor, by performing a frequency analysis of this vibratory signal.

2. The device as claimed in claim 1, wherein the processing unit is configured to calculate, in the frequency analysis, a frequency spectrum over a frequency range at least 500 Hz wide.

3. The device as claimed in claim 1, wherein the processing unit is configured to calculate a quantity representative of the flow rate of the fluid, by integration over a range of frequencies of a quantity representative of the amplitude of the vibrations, this integration being performed preferably over a frequency range ranging from a frequency F_min lying between 50 and 150 Hz.

4. The device as claimed in claim 1, further comprising a support coupled at one of its ends to the obstacle-forming part, and a fixing element making it possible to fix the support to the duct, comprising an element ensuring a vibration-damping function.

5. The device as claimed in claim 1, wherein the vibration sensor is arranged inside the obstacle-forming part.

6. The device as claimed in claim 4, wherein the support has a tubular form.

7. The device as claimed in claim 5, wherein the interior of the support is connected with the internal housing of the obstacle-forming part.

8. The device as claimed in claim 4, wherein the interior of the support receives at least one cable linked to the vibration sensor, the cable making it possible to electrically power the vibration sensor and/or transmit the vibratory signal delivered by the vibration sensor to the processing unit.

9. The device as claimed in claim 4, wherein the fixing element is a cable gland that makes it possible to fix the support to the duct.

10. The device as claimed in claim 4, wherein the fixing element comprises an antivibratory baseplate.

11. The device as claimed in claim 1, further comprising at least one external vibration sensor sensitive to the vibrations of the duct, the processing unit configured to calculate the flow parameter of the fluid from at least the vibratory signal delivered by the vibration sensor and from an external vibratory signal delivered by the external vibration sensor.

12. The device as claimed in claim 1, wherein the flow parameter of the fluid is its speed or its flow rate.

13. The device as claimed in claim 1, wherein the vibration sensor is an accelerometer.

14. The device as claimed in claim 1, wherein the obstacle-forming part has a general form of a sphere, a half-sphere, a disk, a cylinder, a half-cylinder or a beam.

15. The device as claimed in claim 1, wherein the obstacle-forming part has a surface in contact with the flow whose area lies between 1 and 500 cm², better between 1 and 250 cm², even better between 1 and 100 cm².

16. The device as claimed in claim 1, wherein the obstacle-forming part is produced in a metallic material.

17. An installation for measuring at least one flow parameter of a fluid, comprising:
a fluid flow duct,
at least one measurement device as claimed in claim 1, for measuring the flow parameter of the fluid in the duct.

18. The installation as claimed in claim 17, further comprising a plurality of measurement devices in a restricted portion of the duct or distributed along the duct.

19. The installation as claimed in claim 18, wherein the plurality of measurement devices share a single processing unit.

20. The installation as claimed in claim 17, wherein the duct is a ventilation duct.

21. The installation as claimed in claim 17, wherein the length of the obstacle-forming part is less than or equal to half the internal diameter of the duct.

22. A method for measuring at least one flow parameter of a fluid in a duct, using a measurement device as defined in claim 1, comprising the steps of:
a) detecting, using the vibration sensor, the vibrations induced on the obstacle-forming part by the turbulences,
b) calculating, using the processing unit, the flow parameter of the fluid from at least the vibratory signal delivered by the vibration sensor.

23. The measurement method as claimed in claim 22, wherein the fluid is a liquid or a gas.

24. The measurement method as claimed in claim 22, wherein the duct is a ventilation duct.

25. The measurement method as claimed in claim 22, further comprising a step consisting in detecting the vibrations induced on the fluid flow duct using at least one external vibration sensor sensitive to the vibrations of the duct, and in calculating, using the processing unit, the flow parameter of the fluid from at least the vibratory signal delivered by the vibration sensor and from an external vibratory signal delivered by the external vibration sensor.

26. The method as claimed in claim 22, further comprising applying a measurement of the flow rate, comprising the following steps:
a) calculation of a frequency spectrum of the vibratory signal delivered by the vibration sensor detecting the vibrations induced on the obstacle-forming part,
b) calculation of a quantity (P*ₘₐₓ) representative of the speed of the flow, called scalar indicator, by integration over a frequency spectrum from a low frequency F_min to a high frequency F_max of the amplitude of the vibratory signal or of a function X(f) representative thereof,
c) determination of the flow rate or of the speed of flow with a transfer function giving, from the scalar indicator or from the image thereof by a function, the value of the flow rate or the speed of the flow, the parameter or parameters of this transfer function having been determined by prior calibration.

27. The method as claimed in claim 26, wherein the Reynolds number of the flow for which the flow rate is less than 4000.

28. A method for manufacturing a measurement device as claimed in claim 1, wherein the obstacle-forming part is manufactured by an additive manufacturing technique.

29. The manufacturing method as claimed in claim 28, further comprising a step of manufacturing the support by an additive manufacturing technique.
